(19) United States
(12) Patent Application Publication
(10) Pub. No.: US 2008/0126854 A1
(43) Pub. Date: May 29, 2008

(54) REDUNDANT SERVICE PROCESSOR FAILOVER PROTOCOL

(76) Inventors: Gary D. Anderson, Austin, TX (US); Brent W. Jacobs, Rochester, MN (US); William A. Thompson, Rochester, MN (US)

Correspondence Address: DILLON & YUDELL LLP, 8911 N. CAPITAL OF TEXAS HWY.,, SUITE 2110, AUSTIN, TX, 78759, US

(21) Appl. No.: 11/535,532

(22) Filed: Sep. 27, 2006

(51) Int. Cl. G06F 11/20

(52) U.S. Cl. 714/13; 714/E11.072

(57) ABSTRACT

A data processing system (or server) is designed with redundant service processors and a hypervisor. Both service processors are capable of performing the full set of service processor functions, with one service processor (SP) registering itself as a primary SP with the system firmware/hypervisor and the other SP registering as the backup SP. The primary SP performs the initialization, monitoring and control of system resources. The backup SP and hypervisor monitor the primary SP for indications that the primary SP is failing. In the event of a failure of the primary SP, any one of the three components, the backup SP, hypervisor, or even the primary SP itself, is able to initiate a failover to the backup SP. During failover conditions, backup SP checks the system to ensure that there is no ongoing failover before a new failover is initiated

### BACKGROUND OF THE INVENTION

1. Technical Field

The present invention generally relates to computer systems and in particular to handling component failure within computer systems. Still more particularly, the present invention relates to failover protocols for handling component failure within computer systems.

2. Description of the Related Art

Higher-end computer systems are often designed with redundant components, with one component serving (or designated) as a primary component and the other component serving as a backup component. The computer system initially operates with the primary component. When/if the primary component fails, the backup component is activated to take over the responsibilities/functions of the primary component. The process by which operations are switched from a primary component over to a backup component is referred to as a “failover.” Conventionally, component redundancy and failover processes were provided for only certain component-configurations, including, for example, (1) an operating system (OS) providing access control over redundant I/O controllers and (2) an I/O controller providing access control over redundant I/O devices coupled to the I/O controller.

With conventional failover methods, any one of the redundant components or the associated access-controller is able to asynchronously initiate a failover process, and each component-initiated failover is completed independent of the failover of the other components. Thus, failover in response to failure of a primary component failure may be initiated from multiple sources running asynchronously, which results in multiple concurrent failover requests. The existence of these multiple concurrent failovers provides challenges in resynchronization of the three associated components (i.e., the access controller and redundant devices).

To overcome the synchronization problems with overlapping/concurrent failovers from multiple sources, an alternate failover method is provided by which a single source is pre-assigned to drive/control all failover processes. For example, for a system that provides redundant I/O controllers controlled by an OS, the failover is always controlled by the OS, which represents the single source at the access control level. With the second described component-configuration, having a single I/O controller and redundant devices, this single source is the I/O controller.

Additional failover methods simply switch the bus control signals from one component to the redundant (backup) component, leaving the access controller (e.g., the OS for redundant I/O controllers or the I/O controller for redundant devices) unaware that a failover has occurred. However, this failover method does not work within system topologies where the redundant components (e.g., I/O controllers) have buses which do not pass through some sort of multiplexer (MUX). With such topologies, complete failover cannot be accomplished by simply switching which controller's set of signals are selected as the output from the MUX.

### SUMMARY OF THE INVENTION

Disclosed is a method and system for enabling failover of redundant service processors. A data processing system (e.g., a server) is designed with redundant service processors. Both service processors are capable of performing the full set of service processor functions, with one service processor (SP) assuming the role of a primary SP and the other SP designated as the backup SP. The primary SP performs the initialization, monitoring and control of the system resources. The backup SP is available to take over the role of the primary SP at any time the primary SP fails, goes offline, or relinquishes its primary role.

As a part of the initialization of the two SPs, the SPs negotiate between themselves which SP is the primary and which SP is the backup. The SPs then communicate these roles to the hypervisor (or firmware). After a primary SP communicates its role to the hypervisor, the hypervisor ensures that the configuration data stored on the primary SP is up-to-date. The hypervisor indicates this up-to-date status of the primary SP's configuration data by acknowledging the role message received from the primary SP.

During system operation with the primary SP, the backup SP and system hypervisor monitor the primary SP for any indication that the primary SP is no longer performing properly or is exhibiting operating characteristics associated with a “failure”. The particular failure conditions/characteristics being monitored for are preset by the system designer. In the event of a failure of the primary SP, any one (but only one) of the three components, from among the backup SP, hypervisor, or even the primary SP itself, may initiate the failover to the backup SP.

To provide the capability for each one of these multiple components to initiate a failover between SPs without causing overlapping/concurrent failovers, the backup SP always checks whether there is an ongoing failover operation (of the SPs) before the backup SP initiates a new failover. Only when there is no ongoing failover (of the SPs) within the system does the backup SP allow a new failover to begin. Any existing/ongoing failover is permitted to complete on the system, without any overlapping or concurrent failover.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is flow chart illustrating the process of completing a failover that is initiated by the hypervisor/system firmware according to one embodiment of the invention;

FIG. 2 is flow chart illustrating the process of completing a failover that is initiated by the backup service processor (SP) according to one embodiment of the invention;

FIG. 3 is flow chart illustrating the process of completing a failover that is initiated by the primary SP according to one embodiment of the invention;

FIG. 4 is a block diagram representation of an example computer system with primary and backup SPs within which the features of the invention may advantageously be implemented; and

FIG. 5 is a block diagram representation of logical connections between a first and a second SP within a computer system having a control multiplexer (MUX) for providing synchronous failover of a backup SP and control of system hardware resources to the SP that is currently the primary SP, according to one embodiment of the invention.

### DETAILED DESCRIPTION OF AN ILLUSTRATIVE EMBODIMENT

The present invention provides a method and system for enabling synchronous failover of redundant service processors with no overlapping failover operations. A data processing system (e.g., a server) is designed with redundant service processors and a hypervisor. Both service processors are capable of performing the full set of service processor functions, with one service processor (SP) registering itself as a primary SP with the system firmware/hypervisor and the other SP registering as the backup SP. The primary SP performs the initialization, monitoring and control of system resources. The backup SP and hypervisor monitor the primary SP for indications that the primary SP is failing. In the event of a failure of the primary SP, any one of the three components, the backup SP, hypervisor, or even the primary SP itself, is able to initiate a failover to the backup SP. During failover conditions, backup SP checks the system to ensure that there is no ongoing failover before a new failover is initiated.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

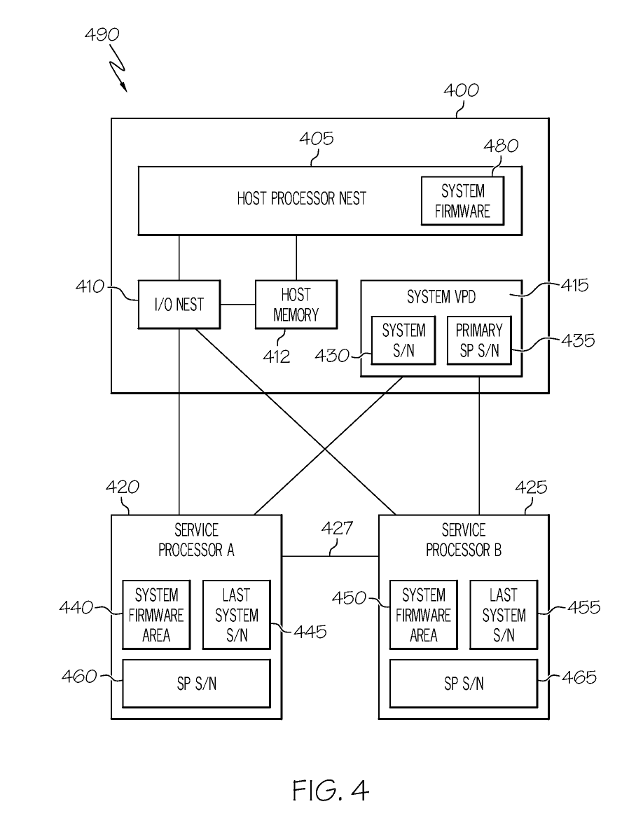

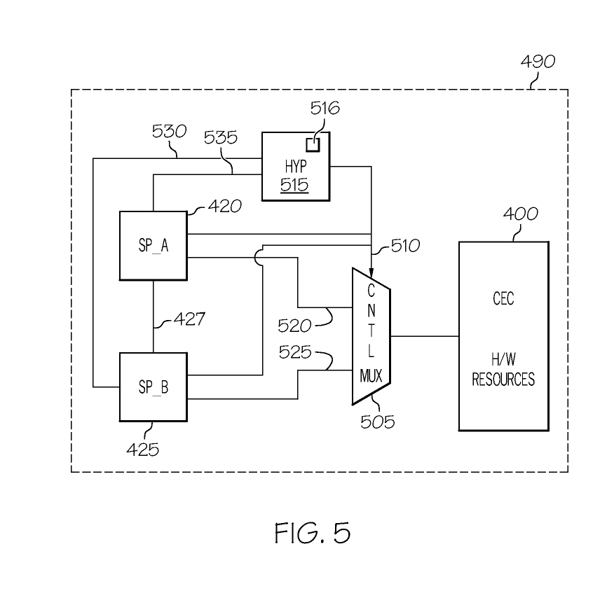

Within the descriptions of the figures, similar elements are provided similar names and reference numerals as those of the previous figure(s). Where a later figure utilizes the element in a different context or with different functionality, the element is provided a different leading numeral representative of the figure number (e.g., 4xx for FIG. 4 and 5xx for FIG. 5). The specific numerals assigned to the elements are provided solely to aid in the description and not meant to imply any limitations (structural or functional) on the invention.

It is further understood that the use of specific parameter names are for example only and not meant to imply any limitations on the invention. The invention may thus be implemented with different nomenclature/terminology utilized to describe the above parameters, without limitation.

With reference now to the figures, FIG. 4 illustrates a simplified block diagram of a computer system having redundant service processors (SP), according to one embodiment of the invention. Computer system 490 comprises Central Electronics Complex (CEC) 400, which includes host processor nest 405, Input/Output (I/O) nest 410, host memory 412 and system Vital Product Data (VPD) 415. Host processor nest 405 is illustrated with system firmware 480, which executes on host processor nest 405. During system operation, system firmware 480 (also interchangeably referred to herein as hypervisor) is loaded into host memory 412 and executed on host processor nest 405. System VPD 415 contains system Serial Number (S/N) 430 and primary SP S/N 435, which is the SN of the SP which last communicated with system firmware 480.

As utilized herein, the term hypervisor refers to a schema within the computer system that allows multiple operting systems to run, unmodified, at the same time, and which provides a measure of robustness and stability to the system. Each OS within the hypervisor operates independently of the others, such that if one operating system crashes, the other OSes would continue working without interruption. Cerrtain embodiments of the invention are described from the perspective of a hypervisor providing access control to the SPs. Alternatively, in other embodiments the accessc cotnrol component is refered to as the system firmware. Those skilled in the art apprecite that the hypervisor is a major portion of the system firmware and references herein to functions being completed by system firmware may interchangeably be referred to as functions completed by the hypervisor, and vice versa. Notably also, the features of the invention are applicable to a computer system with a single OS.

Returning to FIG. 4, in addition to the above components, computer system 490 further comprises two SPs, namely SP A 420 and SP B 425, which are both connected to I/O nest 410 and system VPD 415. Each SP (420, 425) contains memory which stores various information, including: (a) system firmware-specific information 440, 450; (b) last system S/N 445, 455, which is the S/N of the system the particular SP (420, 425) was connected to the last time the SP (420, 425) was powered on; and (c) the SP's own S/N 460, 465.

System firmware 480 provides SP firmware data 440, 450 stored in system firmware area of respective SPs 420, 425. Generally, system firmware 480 is loaded into host memory 412 and executed on host processor nest 405, while functions of system firmware 480 that include SP firmware data 440, 450 may be executed by a dedicated processor (not shown) of respective SPs 420, 425.

Both SPs 420, 425 operate on standby power, while CEC 400 operates on bulk power. SPs 420, 425 and CEC 400 thus exist in separate power domains. Those skilled in the computer arts are familiar with these power terms, as utilized herein. When the computer system's AC (alternating current) line cord is plugged into the electrical socket, only the standby power domain is activated. When standby power is applied to either SP (420/425), the SP (420/425) begins to initialize itself. As part of this initialization, the SP (420/425) determines if the SP (420/425) has a sibling SP connected via communications link 427. If a sibling SP exists, then both SPs 420, 425 decide which is the primary SP and which is the backup SP based on pre-established SP initialization methods. The actual methods by which one of the two SPs (420/425) is selected as primary with the other delegated as backup is not relevant to the discussion of the actual invention, which assumes that the roles of primary SP and backup SP have already been assigned before the failover processing is triggered. The primary SP takes on the role of controlling specific hardware resources of computer system 490 (or CEC 400) and communicating with system firmware 480. The backup SP waits in a state from which the backup SP is able to take over as primary SP in case the current primary SP fails.

To provide the capability for multiple entities to initiate a failover between service processors, the service processors first negotiate between themselves which service processor is the primary and which is the backup. The SPs then communicate these roles to the system firmware/hypervisor. After an SP communicates its role to the hypervisor, the hypervisor ensures that the configuration data stored on the primary SP is up-to-date, and the hypervisor indicates this up-to-date status by acknowledging the role message from the primary SP.

As described in greater details below, during system operation of the control of the primary SP, the backup SP and system hypervisor monitor the primary SP for any indication that the primary SP is no longer performing properly or is exhibiting operating characteristics associated with a failure. The specific failure condition (or operating characteristics) being monitored for is preset by the system designer/engineer. Also, any failing SP indicates its role (primary or backup) and its failover capability to the system firmware. As the roles are determined and then communicated across the various components, surveillance/monitoring between the different components is activated/initiated.

FIG. 5 illustrates an example primary SP failover (resolution) logic by which the invention guarantees that only one SP is able to control certain portions (and/or hardware components) of CEC 400. Specifically, CEC 400 (or specific hardware resources therein) is coupled to the output of multiplexer (MUX) 505, which receives two inputs, each from a respective SP (420, 425). Control signal 510 of MUX 505 is connected to both SPs (420, 425). Input on control signal 510 selectively provides one of the SPs (420/425) with control of the hardware resources of CEC 400, and thus enables the SP (420/425) with such control to carry out the role of primary SP. Thus, MUX 505 controls access to CEC's hardware resources, such as host processor nest 405 and I/O nest 410, as well as other pieces of hardware (not specifically shown) in computer system 490 (FIG. 4). For one of the SPs (420/425) to assume the primary role, that SP (420/425) has to provide control signal 510 to MUX 505, according to the current illustrative embodiment. Since MUX 505 provides a single output/access to CEC's hardware resources 550, only one SP (420/425) is able to take ownership of MUX 505, and thus only that SP (420/425) may control CEC 400 at any given time.

The invention provides multiple implementations on how ownership of MUX 505 may be transferred between SPs (420, 425). However, the illustrative embodiments are described from the perspective that ownership of MUX 505 may only be taken if one of three events occur: (1) the current primary SP gives up ownership, perhaps voluntarily or in response to an external trigger; or (2) watchdog timer 516 (which is maintained by hypervisor 515, in the illustrative embodiment) expires because the primary SP has failed to service watchdog timer 516 within a specified amount of time; or (3) the primary SP fails to provide a “live” signal to the backup SP on communications link 427. For the second condition, primary SP is assumed to automatically update watchdog timer 516 within a pre-set period unless primary SP is failing or is giving up the role of primary SP for administrative reasons.

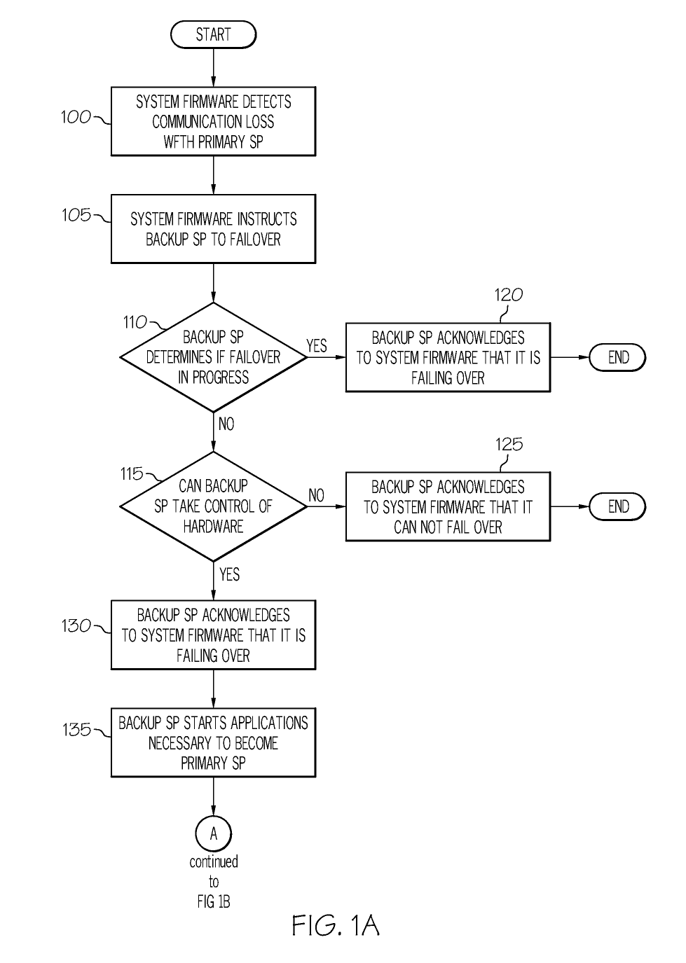

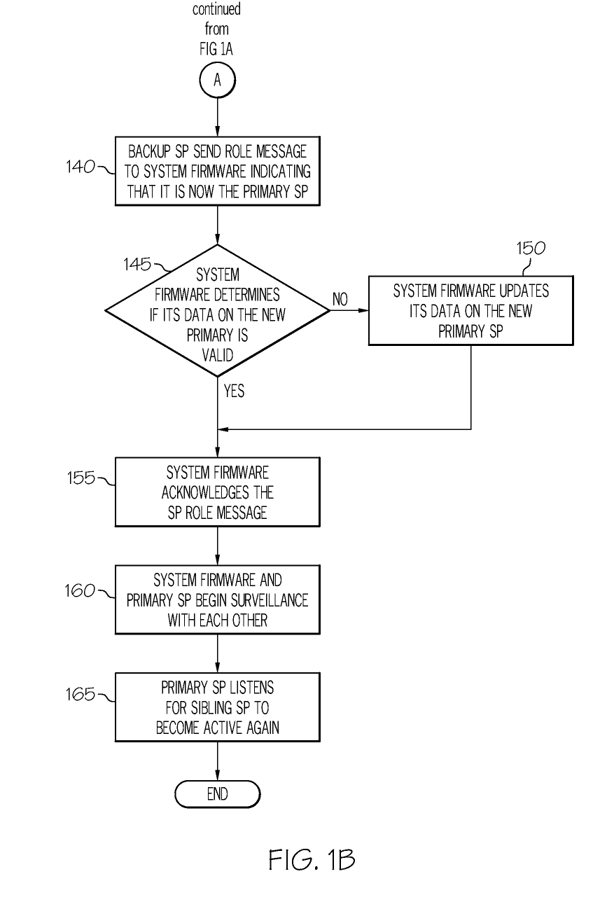

Three different embodiments are provided by the invention, depending on which of the three components, from among the hypervisor, the backup SP, and the primary SP, detects the failure condition and triggers/initiates the failover. Each embodiment is delineated in sections A-C below and illustrated by respective flow charts FIGS. 1-3, described within the respective section below. Notably, the embodiments comprise overlapping processes in the actual implementation. Only one component ultimately completes its failover, however, leading to synchronization of the failover process among the three components and elimination of overlapping failovers.

### A. System Firmware/Hypervisor Initiated Failover

In a first embodiment, when system firmware detects a surveillance failure or communications loss with the current primary SP, the hypervisor instructs the backup SP to become the new primary. The backup SP determines if a failover is already in progress, and when a failover is already in progress, the backup SP acknowledges to the hypervisor that a failover is already ongoing. If a failover is not already in progress, then the backup SP determines if the backup SP is able to gain control of the shared hardware resources. When the backup SP is able to gain control of the shared hardware resources, the backup SP acknowledges to the hypervisor that the backup SP is initiating a new failover.

However, when the backup SP is not able to gain control of the shared hardware resource, then the backup SP waits a pre-specified amount of time for control of the shared hardware resources to become available. Once the shared hardware resources become available, the backup SP asserts the reset line to the primary SP to force the release of the shared hardware and continue with the failover. During the failover, the backup SP starts up any necessary applications to monitor the system (e.g., applications to provide power and thermal monitoring), and then the backup SP notifies the hypervisor that the backup SP has now taken the role as the new primary SP. The hypervisor ensures that the configuration data is synchronized on the new primary SP, and the hypervisor acknowledges the role message. The new primary now begins surveillance with hypervisor and starts “listening” to determine if the old primary comes out of its failure state (e.g., as in the case of a recovered reset/reload).

In order to more clearly described the assignments of primary SP and backup SP and subsequent switching of roles among the SPs, specific illustrative embodiments of the invention are described from the perspective of SP 420 being primary SP (hereinafter primary SP 420) and SP 425 being backup SP (hereinafter backup SP 425). Additionally, once failover occurs, primary SP 420 is also referred to as “previous” primary SP or “new” backup SP, while backup SP 425 is also referred to as “previous” backup SP or “new” primary SP. Each designation is meant to refer to the current role of the particular SP, relative to either the SP's previous role or the previous role of the other SP.

FIG. 1 illustrates the process by which system firmware 480 triggers a failover from primary SP 420 to backup SP 425 of FIGS. 4 and 5, according to the above described first embodiment. The process begins at block 100, which depicts system firmware 480 detecting a communication loss with SP 420, which is currently serving in the role of primary SP 420. Once the communication loss is detected, system firmware 480 instructs backup SP 425 (currently serving in the backup role), to failover and assume the primary role, as indicated at block 105. Backup SP 425 determines at block 110 if a failover is already in progress. If a failover is already in progress, backup SP 425 acknowledges system firmware 480 that a failover is already in progress, and the initial failover is allowed to complete, as provided at block 120. The failover response to the failure detected by system firmware 480 then ends without backup SP 425 activating a failover.

If a failover is not already in progress, then backup SP 425 determines at block 115 if backup SP 425 is able to take control of system hardware 115. If not, then backup SP 425 sends an acknowledgement to system firmware 480 that backup SP 425 is not able to take control of the system hardware and therefore cannot failover, as indicated at block 125.

If, however, backup SP 425 is able to take control of the system hardware, then backup SP 425 acknowledges to system firmware 480 that backup SP 425 is failing over to the primary role, as shown at block 130. At block 135, backup SP 425 starts the necessary applications needed to assume the primary role, and backup SP sends a role message to system firmware 480 indicating that backup SP 425 has now assumed the primary role, as provided at block 140.

System firmware 480 determines, at block 145, if system firmware data 450 on new primary SP 425 is up-to-date. If system firmware data 450 is not up-to-date, system firmware 480 updates system firmware data 450, as shown at block 150, prior to sending new primary SP 425 an acknowledgement to the role message, as indicated at block 155. System firmware 480 and new primary SP 425 then initiates surveillance/monitoring to detect any future communications loss, as indicted at block 160. Also, new primary SP 425 listens on communications link 427 for its sibling SP—now backup SP 420—to become active again, as shown at block 165. Failover processing initiated from system firmware 480 then ends.

### B. Backup SP Initiated Failover

In the second embodiment, the backup SP detects the failure of the primary SP and initiates the failover. When the backup SP detects a surveillance failure with the primary SP, the backup SP will first determine if a failover is already in progress. If a failover is already in progress, then the backup SP takes no action, and the current failover is allowed to continue. However, if a failover is not already in progress, then the backup SP will determine if the backup SP is able to gain control of the shared hardware resources. Assuming the backup SP is able to gain control of the shared hardware resources, the backup SP then notifies the hypervisor that the backup SP is initiating the failover.

On receipt of this notification from the “new primary” SP, the hypervisor ensures that the configuration data is synchronized on the new primary, and the hypervisor acknowledges the role message. The new primary now begins surveillance with the hypervisor and starts “listening” to determine if the old primary comes out of its failure state. The old primary may come out of a failure state following a recovered reset/reload and registers itself as the new backup SP. In one embodiment, if the system firmware is not running, i.e. the system is at standby or initializing, then the backup SP completes the failover to the new primary role without communicating with the system firmware.

When the backup SP is not able to gain control of the shared hardware resources, then the backup SP continues to monitor for the availability of control over the shared hardware resource. This monitoring by the backup SP continues until the backup SP is instructed to failover by the hypervisor. This second failover request (from hypervisor) is provided to handle situations where the backup SP may have itself failed, or situations where the failure may be within the communications link between the two SPs.

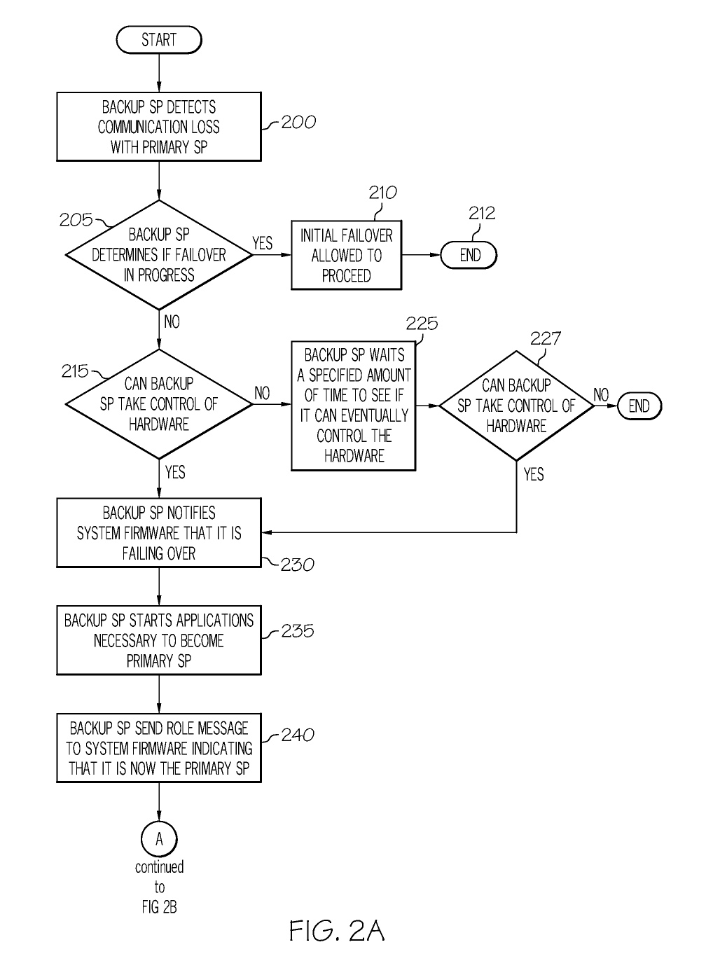

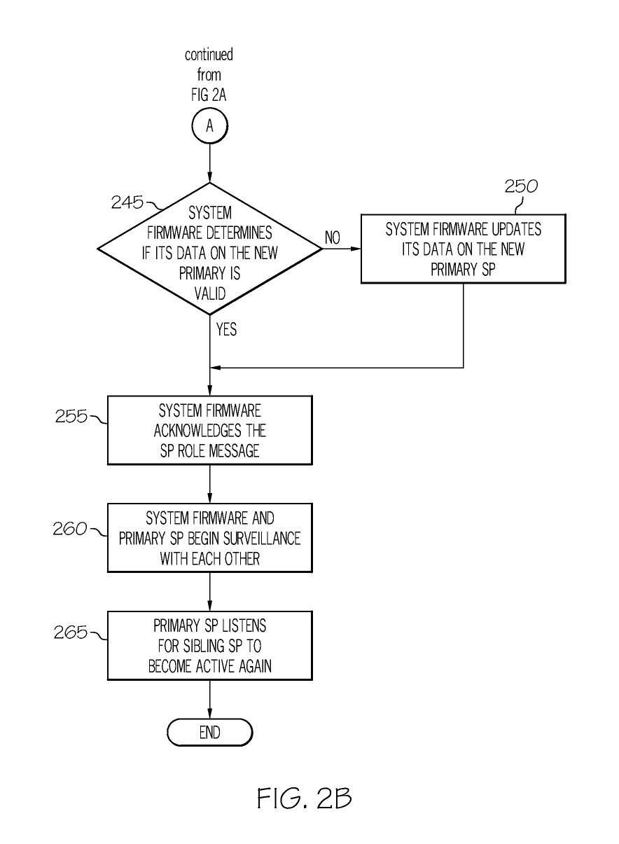

FIG. 2 illustrates the process by which failover is triggered by backup SP 425, within FIGS. 4 and 5, according to the above described second embodiment. The failover process begins when backup SP 425 detects a communication loss with primary SP 420, as shown at block 200. Backup SP 425 determines, at block 205, if a failover is already in progress. If a failover is already in progress, the initial failover is allowed to complete without any further action taken, as shown at block 210, and the failover process triggered by backup SP 425 ends at block 212. This ending of the subsequent failover process (block 212) prevents overlapping failovers from completing within the system.

Returning to block 205, if a failover is not already in progress, then backup SP 425 determines at block 215 if backup SP 425 is able to take control of system hardware. If not, then backup SP 425 waits for a pre-specified amount of time, as indicated by block 225, before retesting whether backup SP 425 is able to take control of the hardware, as determined at block 227. If backup SP 425 is still not able to take control of the hardware, then the failover process ends without a change in roles of primary SP and backup SP. In this situation, an assumption is made that primary SP 420 is still functioning, but communication link 427 has completely failed.

If backup SP 425 is able to take control of the hardware, either after the initial test (block 215) or the retest (block 227), then backup SP 425 notifies system firmware 480 that backup SP is failing over to the primary role, as provided at block 230. Backup SP 425 starts the necessary applications needed to assume the primary role, as indicated at block 235, and backup SP 425 sends a role message to system firmware 480 indicating that backup SP 425 has now assumed the primary role, as shown at block 240. System firmware 480 determines, at block 245, if system firmware data 450 on new primary SP 425 is up-to-date. If system firmware data 450 is not up-to-date, system firmware 480 updates system firmware data 450, as shown at block 250, prior to sending new primary SP 425 an acknowledgement to the role message, as provided at block 255. System firmware 480 and new primary SP 425 begin surveillance with each other to detect any future communications loss, as shown at block 260. New primary SP 425 listens on communications link 427 for its sibling SP—new backup SP 420—to become active again, as indicated at block 265, and the process ends.

With the above embodiment, since both SPs (420, 425) operate on standby power, both SPs (420, 425) may be operating when system firmware 480 is not. For the present embodiment, backup SP 425 is still able to detect a failure in primary SP 420, while the system is at standby or initializing, and the process in FIG. 2 is still followed. However, process blocks in FIG. 2 that depict interaction with or action by system firmware 480 would not occur.

Notably, with the above two embodiments, when/if previous primary SP 420 recovers from the failure that resulted in the failover to new primary SP 425, previous primary SP 420 first communicates with new primary SP 425 to learn that previous primary SP 420 has been delegated to a new role as new backup SP. New backup SP 420 then sends a role message to system firmware/hypervisor 480 to indicate that previous primary, now new backup SP 420 is now the backup and is failover capable. If system firmware/hypervisor 480 is not running, then previous primary SP 420 assumes the backup role and makes itself failover capable without communicating with system firmware/hypervisor 480.

### C. Primary SP Initiated Failover

In the third embodiment, the primary SP is itself able to initiate a failover when the primary SP detects/determines that there is an error/failure related to one of the primary SP's connections to the rest of the system and/or that the primary SP is not able to continue to properly manage the system. Alternatively, the primary SP may be instructed to failover for administrative reasons. Possible administrative reasons include, for example, (a) the result of a code update where the primary SP has to be reset to activate a new code level and (b) a reset prior to a concurrent maintenance action. When the primary SP initiates the failover, the primary SP will first quiesce all applications running on the primary SP and also synchronize any necessary data to the backup SP. The primary SP then gives up control of any shared hardware resources, and instructs the backup SP to failover to the primary role.

On receipt of this instruction from the primary SP, the backup SP first determines if a failover is already in progress. If there is already a failover in progress, the backup SP informs the primary SP that a failover is already in progress, and the existing/ongoing failover is allowed to continue. If a failover is not already in progress, then the backup SP determines if the backup SP is able to gain control of the shared hardware resources. Once the backup SP is able to gain control of the shared hardware resources, the backup SP notifies the hypervisor that the back up SP is failing over. The backup SP then notifies the primary SP that the backup SP is proceeding to assume the role of “new primary” SP. The previous primary SP notifies the hypervisor of its new role as new backup SP. The previous primary SP also notifies the hypervisor that it is either failover capable or not failover capable, depending on the existing condition(s) leading to the failover. Assuming the previous primary SP remains operational, the previous primary SP then begins surveillance/monitoring on the new primary SP.

If the primary SP's failover is for administrative reasons, i.e., not due to some failure with respect to the previous primary SP and/or system connections, the new primary also revalidates all of the system connections to the new primary. However, if the new primary is not able to validate a connection, the new primary returns the primary role to the previous primary SP, and thus the previous backup SP declares itself as not failover capable. The hypervisor ensures that the configuration data is synchronized on the new primary SP and acknowledges the role message. The new primary SP now begins surveillance with PHYP and notifies the old primary SP that the failover is complete. Again, if the hypervisor is not running, then the new primary SP and backup SP will failover without communicating with the hypervisor.

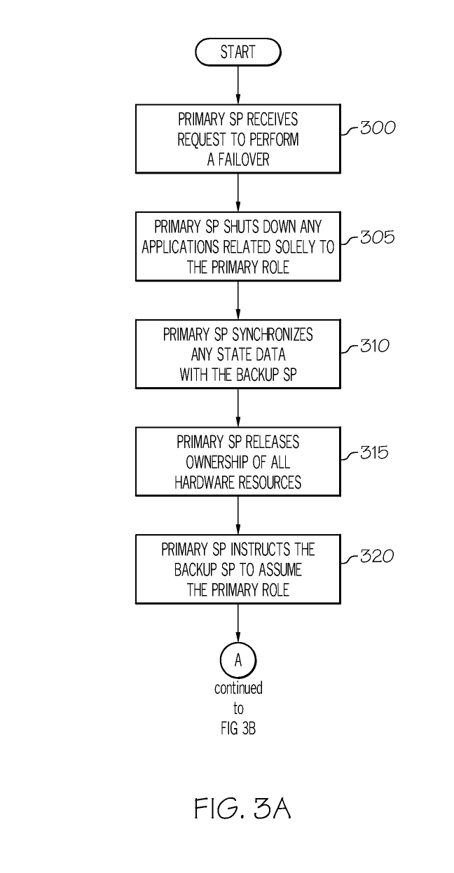

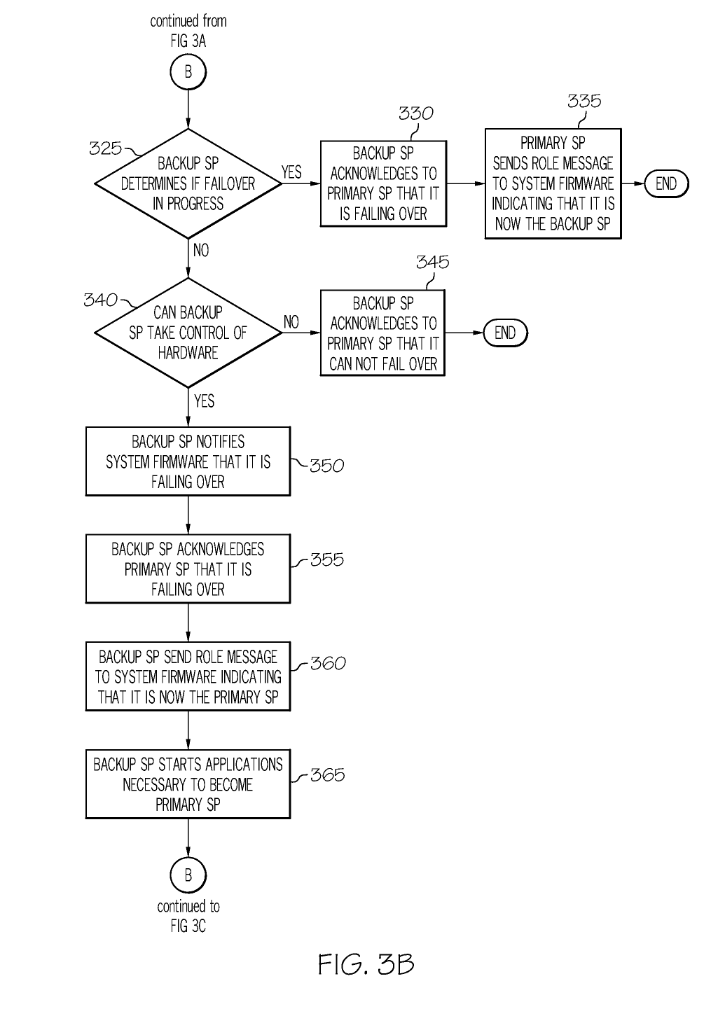

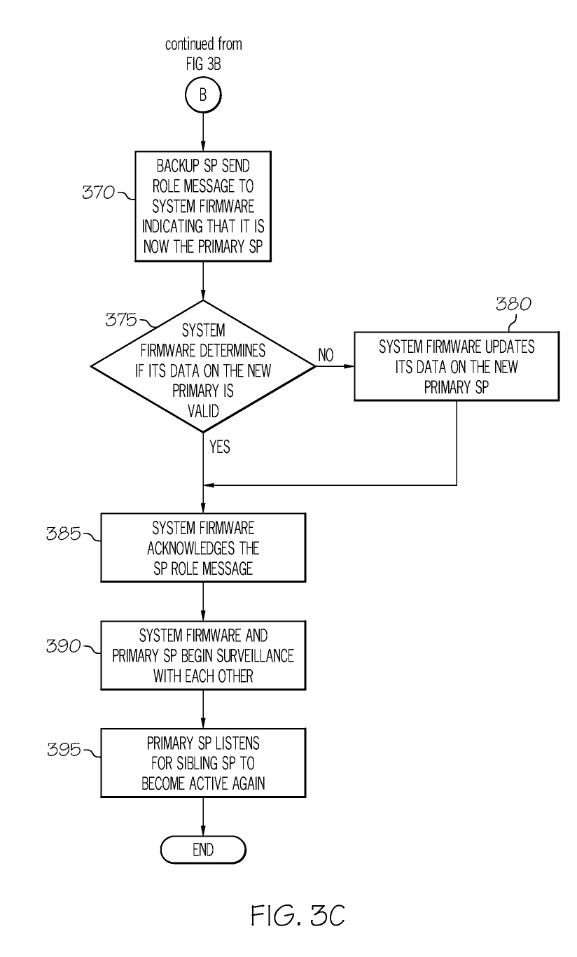

FIG. 3 illustrates the process by which failover is triggered by primary SP 420 of FIGS. 4 and 5, according to the above introduced third embodiment. Primary SP 420 is able to drive the failover process in response to primary SP 420 itself detecting a condition that requires the failover. Alternatively, and as provided within FIG. 3, primary SP 420 may receive a request to failover from another device such as a System Management Console. The process starts at block 300, which shows primary SP 420 receiving a request to failover. As previously stated, this request could be generated internally to primary SP 420 or received from an external source. At block 305, primary SP 420 shuts down any applications related solely to the primary role. Primary SP 420 then synchronizes any specified configuration data with backup SP 425 via communications link 427, as shown in block 310. Following, primary SP 420 releases its ownership of all system hardware resources, as shown at block 315, and primary SP 420 instructs backup SP 425 to begin the failover process, as depicted at block 320.

Backup SP 425 determines at block 325 if a failover is already in progress. If a failover is already in progress, backup SP 425 signals primary SP 420 that a failover is already in progress, as indicated at block 330. Following, primary SP 420 sends a role message to system firmware 480 indicating that primary SP 420 is now assuming the backup role, as shown at block 335. The ongoing (in-progress) failover is allowed to complete without any further action being taken by backup SP 425 with regards to the failover request from primary SP 420.

If, at decision block 325, a failover is not already in progress, then backup SP 425 determines whether backup SP 425 is able to take control of the system hardware, as shown at block 340. If backup SP 425 is not able to take control, then backup SP 425 signals to primary SP 420 that backup SP 425 is not able to take over the system hardware, as indicated at block 345, and then the failover process ends without a change in primary and backup roles. If, however, backup SP 425 is able to take control of the system hardware, then backup SP 425 notifies system firmware 480 that backup SP 425 is failing over to the primary role, as provided at block 350. Additionally, backup SP 425 sends an acknowledgement to previous primary SP 420 that backup SP 425 is failing over, as indicated at block 355. At block 360, previous primary SP 420 sends a message to system firmware 480 that previous primary SP 420 has now assumed the role of new backup SP 420.

Backup SP 425 starts the necessary applications needed to assume the primary role, as shown at block 365, and backup SP 425 sends a role message to system firmware 480 at block 370 indicating that backup SP 425 has now assumed the primary SP role. System firmware 480 determines, at block 375, if system firmware data 450 on new primary SP 425 is up-to-date. If system firmware data is not up-to-date, system firmware 480 updates system firmware data 450, as provided at block 380, prior to sending an acknowledgement of the role message to new primary SP 425, as shown at block 385. System firmware 480 and new primary SP 425 begin surveillance with each other to detect any future communications loss, as indicated at block 390. Also, new primary SP 425 listens on communications link 427 for its sibling SP (420) to become active again, as shown at block 395. Then the process ends.

As with the previous embodiment, since both SPs 420, 425 operate on standby power, both SPs 420, 425 may be operating when system firmware 480 is not. For the present embodiment, primary SP 425 is still able to detect/determine a failure in primary SP 420, and the process in FIG. 3 would still be followed. However, process blocks in FIG. 3 that depict interaction with or action by system firmware 480 would not occur.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A computer system comprising:
a first service processor (SP) designed to control hardware resources of the computer system;
a second SP also designed to control hardware resources of the computer system;
a system firmware executing within the computer system and which maintains (a) current operating parameters and status of the hardware resources as system firmware data and (b) roles assigned to both the first SP and second SP;
first operating means within each of the first SP and the second SP for enabling one of the first SP and the second SP to assume a role of primary SP during initialization of the first SP and the second SP, wherein a next one of the first SP and the second SP is delegated as a backup SP; and
second operating means within each of the first SP, the second SP, and the system firmware, including:
means for monitoring the primary SP for detection of a failure; and
means for synchronously implementing a failover to the backup SP, wherein any one of the first SP, the second SP and the system firmware may initiate a separate failover, but only one failover is permitted to proceed to completion in response to the detection of the failure.

2. The computer system of claim 1, further comprising:
a communications link interconnecting the first SP to the second SP;
wherein said first operating means includes:
means for providing standby power to the first SP and the second SP;
means for each of the first SP and the second SP to detect, via the communications link, a presence of the other SP within the system;
means for said first SP and said second SP to execute an initialization protocol which enables the assumption of a primary role by one of the first SP and the second SP and delegation of the backup role to the other SP; and
means for each of said first SP and said second SP to provide a role message to the system firmware indicating the particular SP's current role from among the primary role and the backup role.

3. The computer system of claim 2, said system firmware further comprising:
means for recording the allocation of the primary role and the backup role;
means for checking the system firmware data maintained within the primary SP;
means, when the system firmware data within the primary SP are not current relative to the current system firmware data maintained by the system firmware, for automatically updating the system firmware data of the primary SP to the current system firmware data; and
means for providing the primary SP with an acknowledgement of the receipt of the role message.

4. The computer system of claim 2, wherein said means for synchronously implementing a failover to the backup SP further comprises:
means for the backup SP to determine if a next failover is already in progress; and
when a next failover is already in progress:
means for the backup SP to acknowledge that the next failover is already in progress, wherein said backup SP permits the next failover to proceed; and
means for terminating the failover triggered after the next failover;
when there is no next failover already in progress,
means for the backup SP to determine if the backup SP is able to take control of the hardware resources; and
when the backup SP is not able to take control of the hardware resources, means for the backup SP to acknowledge that the backup SP is not able to take control of the hardware resources, whereby the backup SP is not able to complete the failover; and
when the backup SP is able to take control of the hardware resources:
means for the backup SP to acknowledge that the backup SP is failing over to the primary role; and
means for said backup SP to complete the failover.

5. The computer system of claim 4, wherein said means for said backup SP to complete the failover comprises:
means for initiating applications required to assume the primary role;
means for sending a role message to the system firmware indicating that the backup SP has assumed the primary role and is now a new primary SP;
means for enabling the system firmware to update system firmware data on the new primary SP;
means for receiving an acknowledgement to the role message from the system firmware; and
means for the new primary SP to monitor the communications link for the other SP to become active again.

6. The computer system of claim 5 wherein, said means for said backup SP to complete the failover comprises:
means for detecting when the system firmware is not online during the failover;
means, when the system firmware is not online, for withholding the sending of the role message to the system firmware;
wherein when the system firmware is not online, only the backup SP and the primary SP are able to detect the failure in the primary SP, and said backup SP and said primary SP do not provide a role message to the system firmware until the system firmware comes online; and
means, when the system firmware later comes online, for automatically sending the role message to the system firmware.

7. The computer system of claim 5, wherein when the failure is detected by the system firmware, said means for synchronously implementing a failover to the backup SP further comprises:
means for detecting a communication loss with the primary SP;
means for signaling the backup SP to failover and assume the primary role; and
when the failover is complete, means for initiating a subsequent monitoring for a detection of future communications loss from the new primary SP.

8. The computer system of claim 5, wherein, when the failure is detected by the backup SP, said means for synchronously implementing a failover to the backup SP further comprises:
means for detecting a communication loss with the primary SP;
when the backup SP is not initially able to take control of the system hardware:
means for the backup SP to wait for a pre-specified amount of time before retrying to take control of the hardware resources;
when the backup SP is not successful in taking control of the hardware resources during the retry, means for terminating the failover process without changing the allocation of the primary role and the backup role; and
when the backup SP is able to take control of the hardware resources during the retry, means for sending the role message.

9. The computer system of claim 5, further comprising:
means for said primary SP to detect one of a plurality of possible situations that triggers a failover to the backup SP, said plurality of possible situations including: (a) loss of communication with the system firmware; (b) loss of communication with the backup SP; (c) initiation of a system maintenance that requires the primary SP to be deactivated; (d) receipt of a request to failover from another device such as a System Management Console; (e) self-detection of an internal failure of the primary SP;
means for said primary SP to initiate the failover to the backup SP, said means including:
means for closing applications related solely to the primary role;
means for synchronizing specified configuration data with the backup SP via the communications link;
means for releasing ownership and control of the hardware resources;
means for first receiving an acknowledgement from the backup SP that the backup SP is failing over; and
means for sending a role message to system firmware indicating that the primary SP is now assuming the backup role.

10. The computer system of claim 5, wherein when a previous primary SP recovers from the failure that resulted in the failover to the new primary SP, said computer system further comprises:
means for said previous primary SP to discover that the new primary SP has assumed the primary role; and
means for said previous primary SP to automatically transmit a next role message to the system firmware to indicate that previous primary SP is now a new backup SP and is failover capable.

11. In a computer system having (1) a first service processor (SP) operating as a primary SP and designed to control hardware resources of the computer system, (2) a second SP operating as a backup SP for enabling failover from the primary SP, and (3) a system firmware, which maintains (a) current operating parameters and status of the hardware resources as system firmware data and (b) roles assigned to both the first SP and second SP, a system comprising:
means for monitoring the primary SP for detection of a failure; and
means for synchronously implementing a failover to the backup SP, wherein any one of the first SP, the second SP and the system firmware may initiate a separate failover, but only one failover is permitted to proceed to completion in response to the detection of the failure.

12. The system of claim 11, further comprising:
means for providing standby power to the first SP and the second SP;
means for each of the first SP and the second SP to detect a presence of the other SP within the system;
means for said first SP and said second SP to execute an initialization protocol which enables the assumption of a primary role by one of the first SP and the second SP and delegation of the backup role to the other SP;
means for each of said first SP and said second SP to provide a role message to the system firmware indicating the particular SP's current role from among the primary role and the backup role; and
wherein said system firmware further includes:
means for recording the allocation of the primary role and the backup role;
means for checking the system firmware data maintained within the primary SP;
means, when the system firmware data within the primary SP are not current relative to the current system firmware data maintained by the system firmware, for automatically updating the system firmware data of the primary SP to the current system firmware data; and
means for providing the primary SP with an acknowledgement of the receipt of the role message.

13. The system of claim 11, wherein said means for synchronously implementing a failover to the backup SP further comprises:
means for the backup SP to determine if a next failover is already in progress; and
when a next failover is already in progress:
means for the backup SP to acknowledge that the next failover is already in progress, wherein said backup SP permits the next failover to proceed; and
means for terminating the failover triggered after the next failover;
when there is no next failover already in progress,
means for the backup SP to determine if the backup SP is able to take control of the hardware resources; and
when the backup SP is not able to take control of the hardware resources, means for the backup SP to acknowledge that the backup SP is not able to take control of the hardware resources, whereby the backup SP is not able to complete the failover; and
when the backup SP is able to take control of the hardware resources:
means for the backup SP to acknowledge that the backup SP is failing over to the primary role; and
means for said backup SP to complete the failover.

14. The system of claim 13, wherein said means for said backup SP to complete the failover comprises:
means for initiating applications required to assume the primary role;
means for sending a role message to the system firmware indicating that the backup SP has assumed the primary role and is now a new primary SP;
means for enabling the system firmware to update system firmware data on the new primary SP;
means for receiving an acknowledgement to the role message from the system firmware; and
means for the new primary SP to monitor the communications link for the other SP to become active again.

15. The system of claim 14, wherein:
said means for said backup SP to complete the failover comprises:
means for detecting when the system firmware is not online during the failover;
means, when the system firmware is not online, for withholding the sending of the role message to the system firmware;
wherein when the system firmware is not online, only the backup SP and the primary SP are able to detect the failure in the primary SP, and said backup SP and said primary SP do not provide a role message to the system firmware until the system firmware comes online; and
means, when the system firmware later comes online, for automatically sending the role message to the system firmware.

16. The computer system of claim 14, wherein:
when the failure is detected by the system firmware, said means for synchronously implementing a failover to the backup SP further comprises:
means for detecting a communication loss with the primary SP;
means for signaling the backup SP to failover and assume the primary role; and
when the failover is complete, means for initiating a subsequent monitoring for a detection of future communications loss from the new primary SP;
when the failure is detected by the backup SP, said means for synchronously implementing a failover to the backup SP further comprises:
means for detecting a communication loss with the primary SP;
when the backup SP is not initially able to take control of the system hardware:
means for the backup SP to wait for a pre-specified amount of time before retrying to take control of the hardware resources;
when the backup SP is not successful in taking control of the hardware resources during the retry, means for terminating the failover process without changing the allocation of the primary role and the backup role; and
when the backup SP is able to take control of the hardware resources during the retry, means for sending the role message.

17. The computer system of claim 14, further comprising:
means for said primary SP to detect one of a plurality of possible situations that triggers a failover to the backup SP, said plurality of possible situations including: (a) loss of communication with the system firmware; (b) loss of communication with the backup SP; (c) initiation of a system maintenance that requires the primary SP to be deactivated; (d) receipt of a request to failover from another device such as a System Management Console; (e) self-detection of an internal failure of the primary SP;
means for said primary SP to initiate the failover to the backup SP, said means including:
means for closing applications related solely to the primary role;
means for synchronizing specified configuration data with the backup SP via the communications link;
means for releasing ownership and control of the hardware resources;
means for sending a role message to system firmware indicating that the primary SP is now assuming the backup role; and
when a previous primary SP recovers from the failure that resulted in the failover to the new primary SP, said system further comprises:
means for said previous primary SP to discover that the new primary SP has assumed the primary role; and
means for said previous primary SP to automatically transmit a next role message to the system firmware to indicate that previous primary SP is now a new backup SP and is failover capable.

18. In a computer system having (1) a first service processor (SP) operating as a primary SP and designed to control hardware resources of the computer system, (2) a second SP operating as a backup SP for enabling failover from the primary SP, and (3) a system firmware, which maintains (a) current operating parameters and status of the hardware resources as system firmware data and (b) roles assigned to both the first SP and second SP, a method comprising:
monitoring the primary SP for detection of a failure; and
synchronously implementing a failover to the backup SP, wherein any one of the first SP, the second SP and the system firmware may initiate a separate failover, but only one failover is permitted to proceed to completion in response to the detection of the failure, wherein said synchronously implementing the failover includes:
determining if a next failover is already in progress; and
when a next failover is already in progress:
acknowledging that the next failover is already in progress, wherein said backup SP permits the next failover to proceed; and
terminating the failover triggered after the next failover;
when there is no next failover already in progress,
determining if the backup SP is able to take control of the hardware resources; and
when the backup SP is not able to take control of the hardware resources, acknowledging that the backup SP is not able to take control of the hardware resources, whereby the backup SP is not able to complete the failover; and
when the backup SP is able to take control of the hardware resources:
acknowledging that the backup SP is failing over to the primary role; and
completing the failover.

19. The method of claim 18, wherein completing the failover comprises:
initiating applications required to assume the primary role;
sending a role message to the system firmware indicating that the backup SP has assumed the primary role and is now a new primary SP;
enabling the system firmware to update system firmware data on the new primary SP;
receiving an acknowledgement to the role message from the system firmware;
monitoring the communications link for the other SP to become active again;
detecting when the system firmware is not online during the failover;
when the system firmware is not online, withholding the sending of the role message to the system firmware;
wherein when the system firmware is not online, only the backup SP and the primary SP are able to detect the failure in the primary SP, and said backup SP and said primary SP do not provide a role message to the system firmware until the system firmware comes online; and
when the system firmware later comes online, automatically sending the role message to the system firmware.

20. The method of claim 19, wherein:
when the failure is detected by the system firmware, said synchronously implementing a failover to the backup SP further comprises:
detecting a communication loss with the primary SP;
signaling the backup SP to failover and assume the primary role; and
when the failover is complete, initiating a subsequent monitoring for a detection of future communications loss from the new primary SP;
when the failure is detected by the backup SP, said synchronously implementing a failover to the backup SP further comprises:
detecting a communication loss with the primary SP;
when the backup SP is not initially able to take control of the system hardware:
waiting for a pre-specified amount of time before retrying to take control of the hardware resources;
when the backup SP is not successful in taking control of the hardware resources during the retry, terminating the failover process without changing the allocation of the primary role and the backup role; and
when the backup SP is able to take control of the hardware resources during the retry, sending the role message.
